(19) United States
(12) Patent Application Publication
(10) Pub. No.: US 2020/0176869 A1
(43) Pub. Date: Jun. 4, 2020

(54) FINGER TYPE ANTENNA

(71) Applicants: Tatung Company, Taipei City (TW); TATUNG UNIVERSITY, Taipei City (TW)

(72) Inventors: Chi-Fang Huang, Taipei (TW); Ruei-Bo Chiou, Taipei (TW); Chih-Jou Lin, Taipei (TW)

(73) Assignees: Tatung Company, Taipei City (TW); TATUNG UNIVERSITY, Taipei City (TW)

(21) Appl. No.: 16/449,481

(22) Filed: Jun. 24, 2019

(30) Foreign Application Priority Data
Dec. 4, 2018 (TW) 107143419

(51) Int. Cl. H01Q 5/335; H01Q 9/42; H01Q 1/38; H01Q 9/30

(52) U.S. Cl. CPC H01Q 5/335; H01Q 9/30; H01Q 1/38; H01Q 9/42

(57) ABSTRACT

The disclosure provides a finger type antenna, including a short-circuit portion, a feeding portion, an open-circuit portion, a ground portion, and a coplanar waveguide. The short-circuit portion has a first end and a second end. The feeding portion has a first end and a second end, wherein the first end of the feeding portion is coupled to the first end of the short-circuit portion. The open-circuit portion includes at least three antenna elements, wherein each antenna element has a first end and a second end, and the first ends of the antenna elements are coupled to each other via the feeding portion. The coplanar waveguide is connected to the second end of the short-circuit portion, the second end of the feeding portion, and the ground portion.

### CROSS-REFERENCE TO RELATED APPLICATION

This application claims the priority benefit of Taiwan application serial no. 107143419, filed on Dec. 4, 2018. The entirety of the above-mentioned patent application is hereby incorporated by reference herein and made a part of this specification.

### BACKGROUND

### Technical Field

The disclosure relates to an antenna structure, and in particular, to a finger type antenna.

### Description of Related Art

In antenna designs, the dual-band or multi-band antenna design is generally achieved based on the feature that the antenna resonates at the ¼ wavelength and the ½ wavelength at the same time. However, a broadband antenna with multiple frequencies that is designed in this manner often has an issue of insufficient matching or insufficient antenna characteristics. Therefore, it is further required to add other elements behind the antenna to achieve matching, and this method is more difficult in design, especially in the high frequency part.

### SUMMARY

In view of the above, the disclosure provides a finger type antenna that can be used to solve the above technical problems.

The disclosure provides a finger type antenna including a short-circuit portion, a feeding portion, an open-circuit portion, a ground portion, and a coplanar waveguide. The short-circuit portion has a first end and a second end. The feeding portion has a first end and a second end, wherein the first end of the feeding portion is coupled to the first end of the short-circuit portion. The open-circuit portion includes at least three antenna elements, wherein each of the antenna elements has a first end and a second end, and the first ends of the antenna elements are coupled to each other via the feeding portion. The coplanar waveguide is connected to the second end of the short-circuit portion, the second end of the feeding portion, and the ground portion.

In an embodiment of the disclosure, the at least three antenna elements include a first antenna element, a second antenna element, a third antenna element, and a fourth antenna element. A first end of the first antenna element is coupled to the first end of the feeding portion. A first end of the second antenna element is coupled to the feeding portion, and the second antenna element is spaced apart from the first antenna element by a first distance. A first end of the third antenna element is coupled to the feeding portion, and the third antenna element is spaced apart from the second antenna element by a second distance. A first end of the fourth antenna element is coupled to the feeding portion, and the fourth antenna element is spaced apart from the third antenna element by a third distance.

In an embodiment of the disclosure, the first distance ranges from 0.1 mm to 5 mm.

In an embodiment of the disclosure, the second distance ranges from 0.1 mm to 5 mm.

In an embodiment of the disclosure, the third distance ranges from 0.1 mm to 5 mm.

In an embodiment of the disclosure, the first antenna element is operated at a frequency band of 2.45 GHz, the second antenna element is operated at a frequency band of 5.15 GHz, the third antenna element is operated at a frequency band of 5.5 GHz, and the fourth antenna element is operated at a frequency band of 5.75 GHz.

In an embodiment of the disclosure, each of the antenna elements has a linear structure.

In an embodiment of the disclosure, one of the at least three antenna elements further includes a bending segment.

In an embodiment of the disclosure, the finger type antenna is printed on a printed circuit board, and the bending segment is bent according to an edge of the printed circuit board.

Based on the above, through the at least three antenna elements operated at different frequency bands in the open-circuit portion, the finger type antenna provided in the disclosure can have both multi-band and broadband characteristics, and it is not required to additionally provide other elements behind the antenna for achieving matching, which is thus easy to design.

To make the aforementioned more comprehensible, several embodiments accompanied with drawings are described in detail as follows.

### BRIEF DESCRIPTION OF THE DRAWINGS

FIG. 1 is a schematic structural diagram of a finger type antenna according to an embodiment of the disclosure.

FIG. 2 is a return loss diagram according to FIG. 1.

FIG. 3 is a schematic structural diagram of another finger type antenna according to FIG. 1.

FIG. 4 is a return loss diagram at each frequency band according to FIG. 3.

FIG. 5 is a schematic diagram of a PCB of a wireless communication device according to an embodiment of the disclosure.

FIG. 6A is a return loss diagram at each frequency band according to FIG. 5.

FIG. 6B is a return loss diagram at each frequency band according to FIG. 5.

### DESCRIPTION OF THE EMBODIMENTS

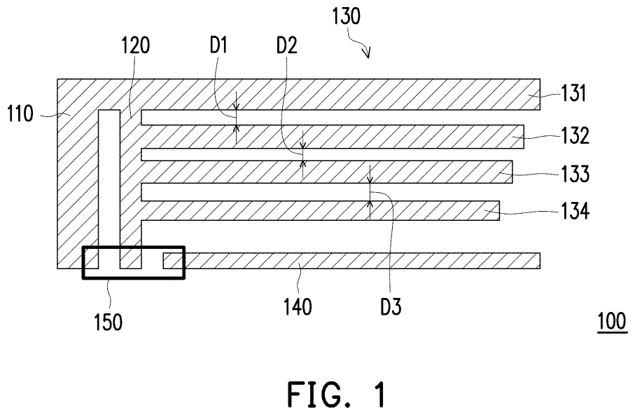

Referring to FIG. 1, FIG. 1 is a schematic structural diagram of a finger type antenna according to an embodiment of the disclosure. As shown in FIG. 1, a finger type antenna 100 includes a short-circuit portion 110, a feeding portion 120, an open-circuit portion 130, a ground portion 140, and a coplanar waveguide 150. The short-circuit portion 110 has a first end and a second end. The feeding portion 120 has a first end and a second end, and the first end of the feeding portion 120 is coupled to the first end of the short-circuit portion 110. The coplanar waveguide 150 is connected to the second end of the short-circuit portion 110, the second end of the feeding portion 120, and the ground portion 140.

In the embodiments of the disclosure, the open-circuit portion 130 may include at least three antenna elements. Each antenna element has a first end and a second end, and the first ends of the antenna elements are coupled to each other via the feeding portion 120.

Taking FIG. 1 as an example, the open-circuit portion 130 may include a first antenna element 131, a second antenna element 132, a third antenna element 133, and a fourth antenna element 134. In FIG. 1, the first end of the first antenna element 131 is coupled to the first end of the feeding portion 120. The first end of the second antenna element 132 is coupled to the feeding portion 120, and the second antenna element 132 is spaced apart from the first antenna element 131 by a first distance D1. The first end of the third antenna element 133 is coupled to the feeding portion 120, and the third antenna element 133 is spaced apart from the second antenna element 132 by a second distance D2. The first end of the fourth antenna element 134 is coupled to the feeding portion 120, and the fourth antenna element 134 is spaced apart from the third antenna element 133 by a third distance D3.

In the present embodiment, the first antenna element 131, the second antenna element 132, the third antenna element 133, and the fourth antenna element 134 may respectively be linear structures having different lengths. In the present embodiment, by adjusting the respective lengths of the first antenna element 131, the second antenna element 132, the third antenna element 133, and the fourth antenna element 134, the first antenna element may be operated at the frequency band of 2.45 GHz, the second antenna element may be operated at the frequency band of 5.15 GHz, the third antenna element may be operated at the frequency band of 5.5 GHz, and the fourth antenna element may be operated at the frequency band of 5.75 GHz. Accordingly, the finger type antenna 100 can be operated under wireless network standards such as IEEE 802.11a, 802.11b, 802.11g, etc., but the disclosure is not limited thereto.

In other embodiments, people of ordinary skill in the art may also adjust the length of each antenna element in FIG. 1 according to the required frequency band. Roughly speaking, since the antenna element resonates at a length of the ¼ wavelength, after the frequency band at which the antenna element is operated is determined, the required length of the antenna element may be correspondingly derived.

Moreover, in an embodiment, to mitigate the interference between the first antenna element 131, the second antenna element 132, the third antenna element 133, and the fourth antenna element 134, the disclosure further derives suitable value ranges of the first distance D1, the second distance D2, and the third distance D3 based on relevant experiment results. In different embodiments, the first distance D1 may range from 0.1 mm to 5 mm, the second distance D2 may range from 0.1 mm to 5 mm, and the third distance D3 may range from 0.1 mm to 5 mm.

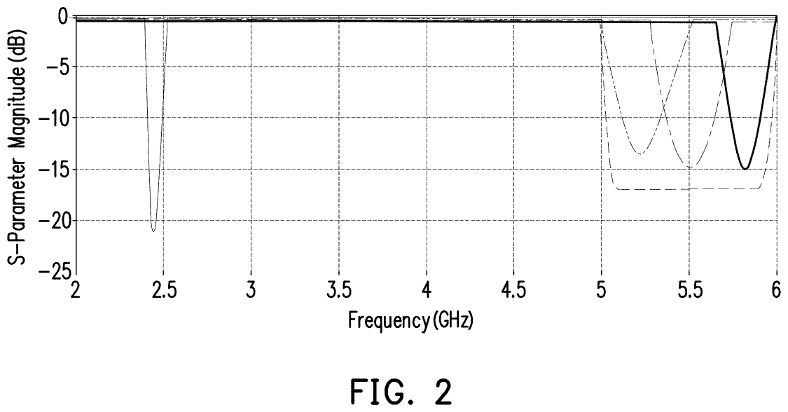

Referring to FIG. 2, FIG. 2 is a return loss diagram according to FIG. 1. As shown in FIG. 1, when the first antenna element 131, the second antenna element 132, the third antenna element 133, and the fourth antenna element 134 are respectively operated at the frequency bands of 2.45 GHz, 5.15 GHz, 5.5 GHz, and 5.75 GHz, the estimated return loss diagram should exhibit two frequency bands of 2.4 GHz and 5 GHz, as shown in FIG. 2. As can be seen from FIG. 2, the broadband at 5 GHz is collectively formed of three frequency bands, which respectively correspond to the second antenna element 132, the third antenna element 133, and the fourth antenna element 134.

As can be seen from the above, through the at least three antenna elements included in the open-circuit portion 130, the finger type antenna provided in the disclosure can have multi-band (e.g., 2.4 GHz and 5 GHz) and broadband characteristics, and it is not required to additionally provide a circuit element behind the antenna for achieving matching, which thereby reduces the difficulty in implementation and is easy to design.

In an embodiment of the disclosure, the finger type antenna 100 may be disposed in a wireless communication device (e.g., a mobile phone, a wireless headphone, etc. but the disclosure is not limited thereto) to transmit and receive relevant RF signals. Moreover, in an embodiment, the finger type antenna 100 may be directly printed on a printed circuit board (PCB), so that the relevant manufacturer does not need to additionally purchase another antenna, which thereby reduces the cost in implementation.

Specifically, in the RF communication module used in the conventional wireless communication device, the used antenna is mostly purchased separately, and circuit calibration is further required so that the operating frequency band of the antenna element is compatible with the requirement of the RF communication module. In this case, the implementation cost will increase due to the additional costs.

However, since the finger type antenna 100 provided in the disclosure may be printed on the PCB at the time of production, it is not required to additionally purchase an antenna element, which thereby achieves the effect of reducing the production cost. Moreover, circuit calibration is not further required to meet the requirement of the RF module.

In an embodiment, if the required operating frequency band is lower, the corresponding antenna element may be presented in a longer form and thus may be less suitable for being disposed in a relatively small wireless communication device such as a wireless headphone. For this reason, the disclosure further correspondingly provides a structural improvement on the basis of FIG. 1 so that the provided finger type antenna can be used in a smaller wireless communication device. The relevant descriptions are as follows.

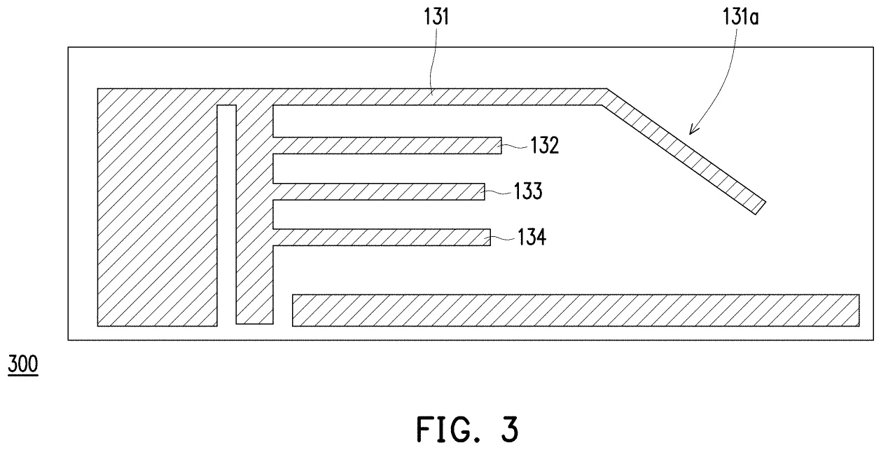

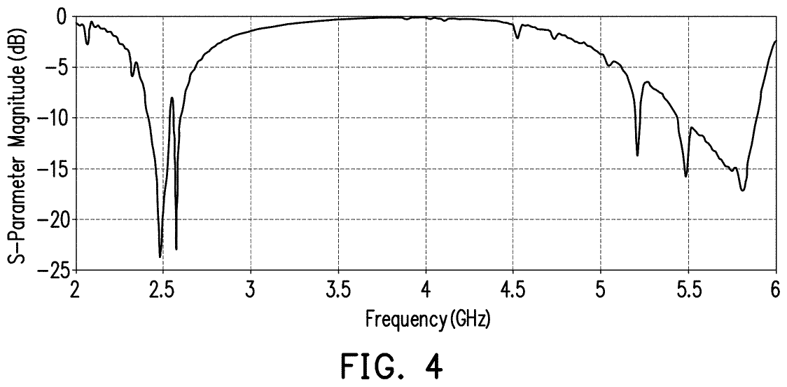

Referring to FIG. 3 and FIG. 4, FIG. 3 is a schematic structural diagram of another finger type antenna according to FIG. 1, and FIG. 4 is a return loss diagram at each frequency band according to FIG. 3. In the present embodiment, the framework of a finger type antenna 300 is substantially the same as that of the finger type antenna 100 in FIG. 1. For ease of illustration, it is assumed here that the first antenna element 131, the second antenna element 132, the third antenna element 133, and the fourth antenna element 134 of the finger type antenna 300 are respectively operated at the frequency bands of 2.45 GHz, 5.15 GHz, 5.5 GHz, and 5.75 GHz, but the disclosure is not limited thereto.

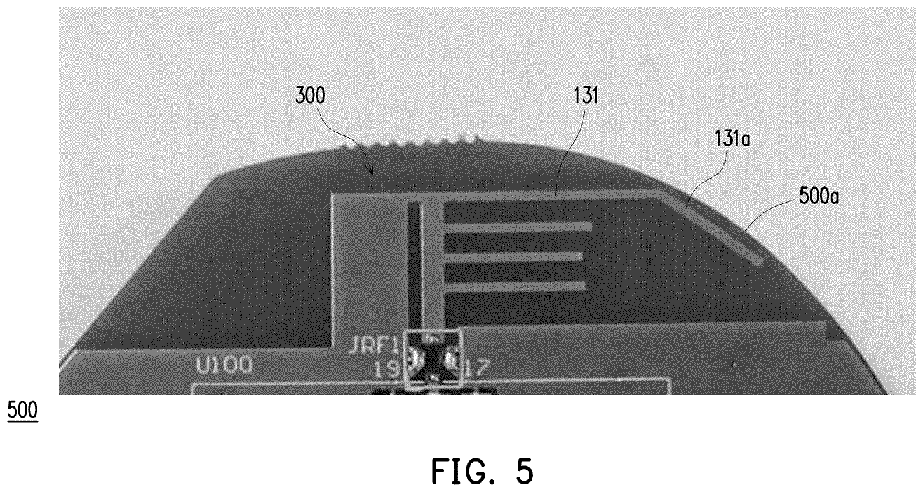

Since the frequency band at which the first antenna element 131 is operated is lower, the first antenna element 131 correspondingly has a greater length. In this case, compared to FIG. 1, the first antenna element 131 in FIG. 3 may be additionally provided with a bending segment 131a. However, as can be seen from FIG. 4, even if the bending segment 131a is present in the first antenna element 131 of FIG. 3, the finger type antenna 300 can still maintain its multi-band (e.g., 2.4 GHz and 5 GHz) and broadband characteristics. In other words, the finger type antenna provided in the disclosure has excellent flexibility in design to be more suitable for being disposed in a smaller wireless communication device. Further descriptions will be provided below with reference to FIG. 5.

Referring to FIG. 5, FIG. 5 is a schematic diagram of a PCB of a wireless communication device according to an embodiment of the disclosure. In the present embodiment, a PCB 500 may be applied, for example, to a wireless communication device such as a wireless headphone, a mobile phone, etc., and the PCB 500 may be printed with the finger type antenna 300 shown in FIG. 3. As shown in FIG. 5, to be adapted to the form of the casing of the wireless communication device, the edge of the PCB 500 may be correspondingly designed to have a curved segment 500a. However, since the bending segment 131a is present in the first antenna element 131 of the finger type antenna 300, compared to the finger type antenna 100 of FIG. 1, the finger type antenna 300 is more suitable for being disposed in the above wireless communication device.

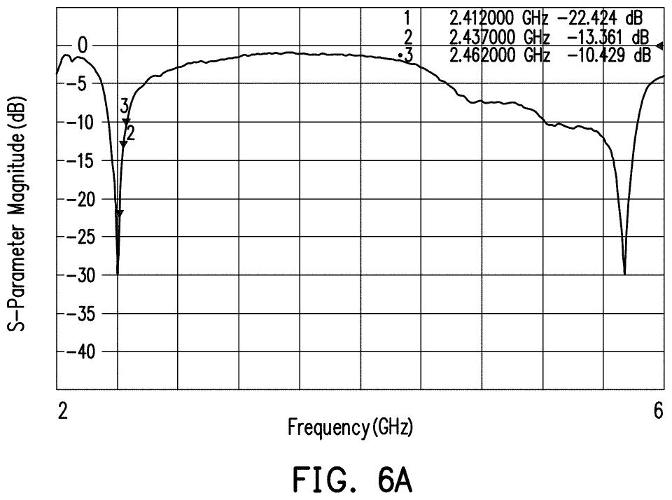

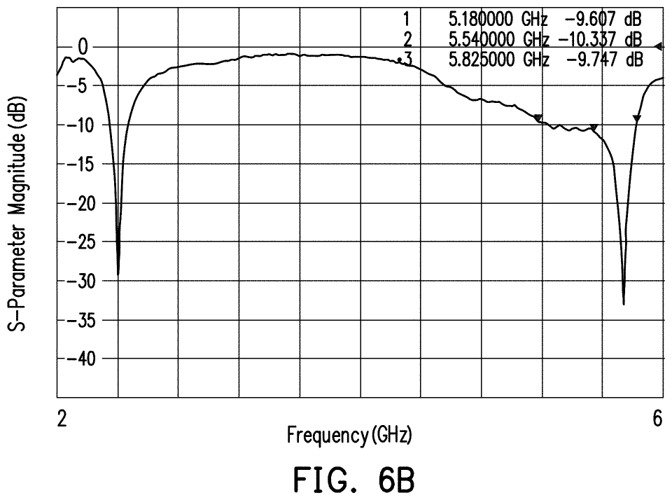

Moreover, as can be learned from the teachings of the embodiments above, the finger type antenna 300 can still maintain its multi-band (e.g., 2.4 GHz and 5 GHz) and broadband characteristics even if the bending segment 131a is present. To support this statement, the disclosure additionally provides return loss diagrams based on measurement of the finger type antenna 300 disposed on the PCB 500, as shown in FIG. 6A and FIG. 6B below.

Referring to FIG. 6A, FIG. 6A is a return loss diagram at each frequency band according to FIG. 5. In FIG. 6A, the frequencies indicated at the upper-right corner are, for example, the low, medium, and high operating points (respectively corresponding to numbers 1, 2, and 3) used in the RF communication module in the 2.4 GHz frequency band. As can be seen from FIG. 6A, the three operating points all fall within the designed bandwidth.

Referring to FIG. 6B, FIG. 6B is a return loss diagram at each frequency band according to FIG. 5. In FIG. 6B, the frequencies indicated at the upper-right corner are, for example, the low, medium, and high operating points (respectively corresponding to numbers 1, 2, and 3) used in the RF communication module in the frequency band of 5 GHz. As can be seen from FIG. 6B, the three operating points similarly all fall within the designed bandwidth.

It can be learned from the above that, in addition to having the multi-band and broadband characteristics, the finger type antenna provided in the disclosure may also be provided with the bending segment according to the requirement and thus has more desirable flexibility in design.

In summary of the above, through the at least three antenna elements included in the open-circuit portion, the finger type antenna provided in the disclosure can have multi-band (e.g., 2.4 GHz and 5 GHz) and broadband characteristics, and it is not required to additionally provide a circuit element behind the antenna for achieving matching, which thereby reduces the difficulty in implementation and is easy to design.

In addition, since the finger type antenna provided in the disclosure may be printed on the PCB at the time of production, it is not required to additionally purchase an antenna element, which thereby achieves the effect of reducing the production cost. Moreover, circuit adjustment is not further required to meet the requirement of the RF module.

Furthermore, the finger type antenna provided in the disclosure may be adaptively provided with the bending segment according to the requirement and thus has excellent flexibility in design and is thereby more suitable for being disposed in a smaller wireless communication device.

Although the disclosure has been disclosed as the embodiments above, the embodiments are not meant to limit the disclosure. Any person skilled in the art may make slight modifications and variations without departing from the spirit and scope of the disclosure. Therefore, the protection scope of the disclosure shall be defined by the claims attached below.

What is claimed is:

1. A finger type antenna comprising:
a short-circuit portion having a first end and a second end;
a feeding portion having a first end and a second end, wherein the first end of the feeding portion is coupled to the first end of the short-circuit portion;
an open-circuit portion comprising at least three antenna elements, wherein each of the antenna elements has a first end and a second end, and the first ends of the antenna elements are coupled to each other via the feeding portion;
a ground portion; and
a coplanar waveguide connected to the second end of the short-circuit portion, the second end of the feeding portion, and the ground portion.

2. The finger type antenna according to claim 1, wherein the at least three antenna elements comprise:
a first antenna element, wherein a first end of the first antenna element is coupled to the first end of the feeding portion;
a second antenna element, wherein a first end of the second antenna element is coupled to the feeding portion, and the second antenna element is spaced apart from the first antenna element by a first distance;
a third antenna element, wherein a first end of the third antenna element is coupled to the feeding portion, and the third antenna element is spaced apart from the second antenna element by a second distance; and
a fourth antenna element, wherein a first end of the fourth antenna element is coupled to the feeding portion, and the fourth antenna element is spaced apart from the third antenna element by a third distance.

3. The finger type antenna according to claim 2, wherein the first distance ranges from 0.1 mm to 5 mm.

4. The finger type antenna according to claim 2, wherein the second distance ranges from 0.1 mm to 5 mm.

5. The finger type antenna according to claim 2, wherein the third distance ranges from 0.1 mm to 5 mm.

6. The finger type antenna according to claim 2, wherein the first antenna element is operated at a frequency band of 2.45 GHz, the second antenna element is operated at a frequency band of 5.15 GHz, the third antenna element is operated at a frequency band of 5.5 GHz, and the fourth antenna element is operated at a frequency band of 5.75 GHz.

7. The finger type antenna according to claim 1, wherein each of the antenna elements has a linear structure.

8. The finger type antenna according to claim 1, wherein one of the at least three antenna elements further comprises a bending segment.

9. The finger type antenna according to claim 8, wherein the finger type antenna is printed on a printed circuit board, and the bending segment is bent according to an edge of the printed circuit board.
